(19) United States
(12) Patent Application Publication
(10) Pub. No.: US 2025/0263300 A1
(43) Pub. Date: Aug. 21, 2025

(54) Handling Carbon Nanoparticles Produced From Methane Pyrolysis

(71) Applicant: Halliburton Energy Services, Inc., Houston, TX (US)

(72) Inventors: Philip D. Nguyen, Houston, TX (US); Ronald Glen Dusterhoft, Houston, TX (US); Stanley Vernon Stephenson, Duncan, OK (US); Linping Ke, Houston, TX (US)

(73) Assignee: Halliburton Energy Services, Inc., Houston, TX (US)

(21) Appl. No.: 18/581,248

(22) Filed: Feb. 19, 2024

(51) Int. Cl. C01B 32/15; C01B 3/24; C01B 3/52; H01M 8/0612

(52) U.S. Cl. CPC C01B 32/15; C01B 3/24; C01B 3/52; H01M 8/0631; C01B 2203/1241

(57) ABSTRACT

Disclosed herein are methods and systems of powering wellbore equipment using hydrogen produced from pyrolysis of methane, and, more particularly to methods of methane pyrolysis which include capturing generated carbon nanoparticles in a separator to form a composition which includes the carbon nanoparticles. The systems include a pyrolysis unit fluidly connected to a methane feed, a separation unit fluidly connected to the pyrolysis unit, and a blending unit fluidly connected to the separation unit for blending a liquid with a solid product from the separation unit. The methods include pyrolyzing at least a portion of the methane from a methane containing stream to form a product stream comprising at least hydrogen and carbon nanoparticles and contacting at least a portion of the carbon nanoparticles with a liquid to form a composition comprising the liquid and the carbon nanoparticles.

### BACKGROUND

During the drilling and completion of oil and gas wells, various wellbore treatments are performed on the wells for a number of purposes. For example, hydrocarbon-producing wells are often stimulated by hydraulic fracturing operations, wherein a servicing fluid such as a fracturing fluid may be introduced into a portion of a subterranean formation penetrated by a wellbore at a hydraulic pressure sufficient to create or enhance fractures therein. Such a fracturing treatment may increase hydrocarbon production from the well.

At a well stimulation site, there are typically several large pieces of fracturing (or other well stimulation) equipment on location that must be powered including, but not limited to, mixers, liquid handling equipment, sand handling equipment, downhole blenders, a plurality of high-pressure hydraulic pumping units, and a control center. The equipment on location is used to deliver large quantities of fluid/proppant mixtures to a wellhead at high-pressures to perform the desired operations. Often, the hydraulic pumping units and other machinery on location are powered by diesel engines. In general, these diesel engines operate at relatively low efficiencies (e.g., approximately 32%). The stimulation site will often include several individual diesel-powered units (e.g., pumping units, blenders, etc.) that must be refueled multiple times a day throughout a multi-stage stimulation operation.

Hydrogen is seen as one of the most promising energy vectors to replace diesel fuel. Hydrogen can be used to directly drive equipment, such as by combustion of the hydrogen, or may be used in a fuel cell to generate electricity which may then be used to power equipment. Many efforts are being made to produce hydrogen without any carbon dioxide (CO₂) emission via water electrolysis powered by renewable energy, for instance. Another method to produce hydrogen is conventional coal gasification and steam methane reforming processes; however, these techniques are undesirable due to carbon dioxide emissions. Thermal decomposition of methane produces hydrogen and solid carbon, and thus, the release of greenhouse gases is prevented.

The solid carbon is typically in the form of carbon nanoparticles. This nanoparticle material is extremely low in density which makes the nanoparticle readily fluidize in air potentially exposing operators to a hazardous condition. Carbon nanoparticles can become flammable when stored in quantity and additionally, carbon nanoparticles tend to become statically charged as they are captured and handled presenting a risk of explosion.

### BRIEF DESCRIPTION OF THE DRAWINGS

These drawings illustrate certain aspects of some of the embodiments of the present disclosure and should not be used to limit or define the disclosure.

FIG. 1 is a flowchart showing a method of powering wellbore using hydrogen in accordance with some embodiments of the present disclosure.

FIG. 2 is a flowchart showing a method of powering wellbore using hydrogen in accordance with some embodiments of the present disclosure.

FIG. 3 is a black and white photograph of a carbon nanoparticle slurry prepared in accordance with some embodiments of the present disclosure.

FIG. 4 is a black and white photograph of a carbon nanoparticle slurry prepared in accordance with some embodiments of the present disclosure.

### DETAILED DESCRIPTION

Disclosed herein are methods and systems of powering wellbore equipment using hydrogen produced from pyrolysis of methane, and, more particularly to methods of methane pyrolysis which include capturing generated carbon nanoparticles in a separator to form a composition which includes the carbon nanoparticles. The liquid stream enables safe handling of carbon nanoparticles by mitigating the generation of fine carbon dust in the air and static charging during handling.

Methane pyrolysis includes heating methane under conditions to thermally crack methane into molecular hydrogen gas and solid carbon where the overall reaction is shown by Reaction 1.

$${CH}_{4} ( g ) {\to }^{Δ} C ( s ) + 2 {H}_{2} ( g ) ΔH ° = 74.91 \frac{kJ}{mol} \qquad Reaction 1$$

Methane pyrolysis occurs in the absence of oxygen where multiple endothermic reactions split C—H bonds to form carbon nanoparticles (C₍ₛ₎) and molecular hydrogen gas. In embodiments, the methane pyrolysis is performed in a microwave pyrolysis unit configured to perform microwave plasma pyrolysis and/or microwave-assisted pyrolysis. In embodiments, the microwave pyrolysis unit comprises a plasma chamber, a microwave-feeding resonator with a microwave generator for forming the plasma and coupling points in the metal wall between the resonator and plasma chamber for coupling the microwave into the plasma chamber. In embodiments, an inlet stream containing methane is introduced into the plasma chamber and exposed to microwave plasma with a sufficient power density to cause at least a portion of the methane from the inlet stream to decompose to form hydrogen and carbon nanoparticles. In further embodiments, the methane pyrolysis is performed in a plasma microwave pyrolysis unit comprising a reaction chamber positioned within an opening of a waveguide and a microwave generator configured to generate microwaves and feed the microwaves into the waveguide. In embodiments, an inlet stream containing methane is introduced into the reaction chamber and microwave energy is propagated through the waveguide into the reaction tube at a sufficient power density to cause at least a portion of the methane from the inlet stream to decompose to form hydrogen and carbon nanoparticles.

An inlet stream to the microwave pyrolysis unit includes methane. The inlet stream may include pure methane or methane mixed with other hydrocarbons such as ethane, propanc, butane, hexane, and heteroatom containing hydrocarbon species. For example, the inlet stream may include pipeline quality natural gas containing 92 wt. % to 98 wt. % methane with the balance being natural gas liquids and impurities. Methane gas (CH₄) can be released from wellheads as well as from various production equipment such gas/liquid separators, oil/water separators, and other surface production equipment. Production storage tanks are used to hold produced liquids including crude oil, water, and gas condensate for periods before pipelining or other transportation of produced liquids. Crude oil and condensate may experience evaporation from temperature increases and pressure drops while in the storage tanks which cause gases dissolved in the liquid to flash out of the liquid phase to form a vapor phase which is rich in methane. The vapor phase may be captured and directed to microwave pyrolysis units described herein. Membrane separators, and/or metal organic frameworks, can be used to separate and purify methane from other gas components at the wellsite before capture. In some embodiments, the methane gas may include waste gas that is typically flared such as during the production and pipelining of hydrocarbons. In some embodiments, methane gas from a wellhead may be supplemented with additional methane fuel delivered to the location. Additional examples of suitable methane sources include captured methane from the wellhead, captured methane from landfills, captured methane from cattle and dairy farms, or captured methane from steam methane reforming. In further embodiments, the methane is included in a hydrocarbon mixture with other hydrocarbons, water, and/or sulfur containing compounds, for example. In embodiment, the feed to a decomposition reactor includes a Y-Grade hydrocarbon which may include hydrocarbons such as ethane, propane, butane, hexane. Y-grade is a natural gas liquid mixture that has been through field processing but has not been fractionated. Y-grade hydrocarbons are typically separated from natural gas before pipelining the natural gas product. In some examples, the inlet stream to the microwave pyrolysis unit includes produced methane, captured methane, or both.

Produced methane, such as from wellheads and gas/liquid separators may be distinguished from pipeline quality natural gas as the produced methane is present in a more dilute mixture with other hydrocarbons such as C₂-C₆ hydrocarbons as well as water, hydrogen sulfide, carbon dioxide, and nitrogen, for example. Specifications for pipeline quality natural gas can vary by pipeline carrier but typically includes specification for heating value and minimum content of methane of at least 75 wt. % as well as a maximum total sulfur content (mercaptan and hydrogen sulfide). The concentration of mercaptan may vary from 1 part per million (ppm) to 30 ppm to ensure that natural gas as an odor in case of gas leak. In embodiments, the inlet stream to the microwave pyrolysis unit includes produced methane wherein the inlet stream comprises methane in an amount of about 10 wt. % to about 95 wt. %, about 25 wt. % to about 90 wt. %, about 50 wt. % to about 80 wt. %, or about 60 wt. % to about 75 wt. %, with the balance being at least one of C₂-C₆ hydrocarbons as well as water, mercaptan, hydrogen sulfide, carbon dioxide, and nitrogen.

Natural gas is primarily composed of methane, but it also contains small amounts of other hydrocarbons, as well as non-hydrocarbon gases. The exact composition of natural gas can vary depending upon the geological formation from which it is extracted, but the typical composition found in natural gas pipelines includes methane (CH₄). Methane is the primary component of natural gas, typically accounting for around 70% to 90% of its composition. Methane is a simple hydrocarbon with one carbon atom and four hydrogen atoms. Ethane (C₂H₆) is another hydrocarbon found in natural gas, usually making up about 5% to about 15% of its composition. It consists of two carbon atoms and six hydrogen atoms. Propane (C₃H₈) is a heavier hydrocarbon present in natural gas, comprising about 0.5% to 5% of its composition. It contains three carbon atoms and eight hydrogen atoms. Butanes (C₄H₁₀) including both normal butane (n-butane) and isobutane (i-butane), are also present in natural gas, usually in smaller amounts compared to methane, ethane, and propane. Natural gas may contain small amounts of pentanes (C₅H₁₂) and heavier hydrocarbons, such as hexane (C₆H₁₄), heptane (C₇H₁₆), and octane (C₈H₁₈). Carbon Dioxide (CO₂) is a common impurity found in natural gas, typically present in concentrations ranging from about 1% to about 8%. Nitrogen (N₂) is often found in natural gas, usually in concentrations ranging from about 0.5% to about 5%. It is considered an inert gas and does not contribute to the heating value of the gas. Hydrogen Sulfide (H₂S) is a trace component of natural gas, present in very low concentrations (usually less than about 1%). It is a toxic and corrosive gas that needs to be removed during processing. Water vapor (H₂O) is often present in natural gas, especially in wet gas fields. It can condense under certain temperature and pressure conditions, leading to the formation of liquid water and potential pipeline corrosion issues.

A product stream from the microwave pyrolysis unit includes hydrogen gas and carbon nanoparticles. The product stream may further include pyrolysis products from the pyrolysis of other components in the inlet stream such as C₂-C₆ hydrocarbons as well as unreacted hydrocarbons and/or hydrogen sulfide, nitrogen, carbon dioxide, and water.

Generally, the term “nanoparticle” may be defined as a particle having a Dv50 particle size of less than 1 micron, for example; about 1 nanometer (“nm”) to about 950 nm, such as about 5 nm, about 10 nm, about 20 nm, about 30 nm, about 40 nm, about 50 nm, about 60 nm, about 70 nm, about 80 nm, or about 90 nm, about 100 nm, about 500 nm, about 750 nm, about 950 nm, or any ranges therebetween. The Dv50 particle size may also be referred to as the median particle size by volume of a particulate material. The Dv50 particle size is defined as the maximum particle diameter below which 50% of the material volume exists. The Dv50 particle size values for a particular sample may be measured by commercially available particle size analyzers such as those manufactured by Malvern Instruments, Worcestershire, United Kingdom. The carbon nanoparticles can include single wall carbon nanotubes, multi wall carbon nanotubes, fullerenes, graphene, and combinations thereof. Particulate, particle, and derivatives thereof as used in this disclosure, include, all known shapes of materials, including substantially spherical materials, low to high aspect ratio materials, fibrous materials, polygonal materials (such as cubic materials), and mixtures thereof. In embodiments, the carbon nanoparticles produced in the microwave pyrolysis unit may be discrete particles or may be agglomerations of small particles or aggregated clusters.

In embodiments, the product stream from the microwave pyrolysis unit is introduced into a separation unit which separates components of the product stream. The separation unit may be configured to separate the product stream into a gas stream containing the hydrogen and other gasses present in the product stream, and a solid product containing the carbon nanoparticles. In embodiments, the separation unit includes structures and equipment capable of separating the carbon nanoparticles from the bulk gas of the product stream from the microwave pyrolysis unit. Separation units may include inertial separators such as rotary flow dust separators, cyclones, and co-current centrifugal separators, a baghouse filter system, venturi scrubbers, electrostatic separators, or any combination thereof. In some embodiments, a production stream exiting from the methane microwave pyrolizer containing hydrogen gas and solid carbon particles is introduced into a vessel containing either an aqueous-based solution, or an oil-based solution, while this solution is being mixed/stirred using a stirring device. Solid carbon particles are retained in the solution to form a slurry of solid carbon while hydrogen is separated and released from the solution to be collected and stored in a separate vessel.

In some examples, the gas stream includes hydrogen in an amount greater than 50 mol. %, or greater than 75 mol. %, or greater than 90 mol. %, for example. In further examples, the gas stream includes greater than 50 mol. % of the hydrogen from the product stream from the microwave pyrolysis unit, or greater than 75 mol. % of the hydrogen, or greater than 90 mol. % of the hydrogen. In further examples, the solid products contain greater than 50 mol. % of carbon nanoparticles from the product stream from the microwave pyrolysis unit, greater than 75 mol. % of the carbon nanoparticles, greater than 90 mol. % of the carbon nanoparticles, greater than 95 mol. % of the carbon nanoparticles, or greater than 99 mol. % of the carbon nanoparticles.

In embodiments, the production of carbon nanoparticles is not steady state. For example, the amount of hydrogen needed to power wellbore equipment downstream of the microwave pyrolysis unit may vary and therefore the mass of methane pyrolyzed, and mass of carbon nanoparticles produced, may vary with time. Additionally, the separator itself may output unsteadily as plug flow. In embodiments, an optional second separator may be utilized to provide a steady state flow to a downstream blending unit. In embodiments, the second separator includes a steady flow separator.

In some embodiments, separation is performed using two or more separation units wherein the solid product is transported from the first separation unit to the second separation unit or from one separation unit to the following separation unit flowing an additional gas such as nitrogen or inert gasses such as helium, neon, argon, krypton, xenon, or radon. At least part of the additional gas is removed before a blending unit.

From the separation unit or optional second separator, the solid product containing the carbon nanoparticles is introduced into a blending unit which is configured to mix the carbon nanoparticles with a liquid to provide a composition (e.g., slurry or a paste) containing the carbon nanoparticles and the liquid. In embodiments, the carbon nanoparticles and liquid are contacted and mixed using mixing equipment present in the blending unit. For example, the mixing equipment can include a jet mixer, mixing tank with agitation, or may include an in-line mixer.

The liquid can include aqueous-based liquids or oil-based liquids. In embodiments, the carbon nanoparticles are dispersed in an oil-based liquid to form a slurry of concentrated carbon nanoparticles. The concentration of carbon nanoparticles in the oil-based liquid may range from about 1% w/v to about 75% w/v, from about 1% w/v to about 50% w/v, or from about 5% w/v to about 25% w/v, or from about 10% w/v to about 20% w/v. In further embodiments, the carbon nanoparticles are dispersed in an aqueous-base fluid to form a slurry of concentrated carbon nanoparticles. The concentration of solid carbon material in the aqueous-based liquid may range from about 1% w/v to about 75% w/v, from about 1% w/v to about 50% w/v, or from about 5% w/v to about 25% w/v, or from about 10% w/v to about 20% w/v.

In embodiments where an aqueous-based liquid is used in the blending unit, water and dissolved components may be included in the aqueous base liquid. For example, aqueous-based fluids may include, without limitation, a freshwater, saltwater (e.g., water containing one or more salts dissolved therein), brine (e.g., saturated saltwater produced from subterranean formations), seawater, or combinations thereof. Generally, the water may be from any source, provided that the water does not contain an excess of compounds that may undesirably affect other components in the settable composition. In some embodiments, the water may be included in an amount sufficient to form a pumpable or flowable slurry. In embodiments the water may be produced water from hydrocarbon extraction and separation such as from an oil-water separator associated with surface production equipment.

Optionally, the aqueous-based liquid includes a water-wetting surfactant, among other reasons, to aid in the suspension of the carbon nanoparticles. Generally, any surfactant that does not interact negatively with the nanoparticles will be suitable especially those surfactants with an HLB greater than or equal to 10. In certain embodiments, it may be desirable to select a surfactant that will emulsify the carbon nanoparticles. In certain embodiments, the surfactants may be present in an amount sufficient to suspend the nanoparticles. This amount may depend on, among other things, the type of surfactant used, the amount of the nanoparticles to be suspended, etc. Examples of surfactants include anionic surfactants such as sodium dodecyl sulfate, sodium dodecyl benzene sulfonate, alkyl benzene sulfonate, nonionic surfactants such as polyoxyethylene sorbitan based surfactants, ethoxylated nonylphenol surfactant, ethoxylated alcohols, alkyl polyglucoside, alkanolamide surfactant, and combinations thereof. When used, the water-wetting surfactant may be present in the aqueous-based liquid in an amount of about 0.01% v/v to about 10% by v/v, or from about 0.01% v/v to about 1.0% by v/v, or from about 1.0% v/v to about 5.0% by v/v, or from about 5.0% v/v to about 10% by v/v, or any ranges therebetween.

In certain embodiments, the treatment fluids may also comprise additional components to enhance, among other things, the performance of the nanoparticles in specific applications. For example, some embodiments may comprise a viscosifier to aid in suspending the nanoparticles in the slurry. Without limitation, suitable viscosifying agents may include colloidal agents (e.g., clays such as bentonite), diatomaceous earth, biopolymers (e.g., xanthan gum, guar gum, chitosan, polysaccharides), synthetic polymers (e.g., polyacrylates, polyacrylamides), or mixtures thereof.

In embodiments, where an oil-based liquid is used in the blending unit, the oil-based liquid can include mineral oils, hydraulic oils, silicon oils, transformer oils, short chain hydrocarbons, glycol ethers, and combinations thereof. Some examples of suitable oil-based liquids include, but are not limited to, branched, linear, and cyclic saturated, unsaturated, and/or aromatic C₆-C₂₀ hydrocarbons, branched, linear, and cyclic C₆-C₂₀ alcohols, ethylene glycol monomethyl ether, ethylene glycol monobutylether, polypropylene glycol, and any combinations thereof.

In some embodiments, the separation unit and the blending unit may be combined. For example, the product stream from the microwave pyrolysis unit may be introduced into a vessel comprising the oil-based liquid and/or the aqueous-based liquid, for example, while stirring, to form a slurry. Solid carbon nanoparticles may be retained in the slurry while a gas stream comprising hydrogen may be separated from the slurry. The gas stream, for example, may be collected and stored in a separate vessel.

In some embodiments, the slurry of the oil-based liquid and the carbon nanoparticles may have a high concentration of carbon nanoparticles. Therefore, the slurry may be in the form of a paste. For example, the paste may have a concentration of carbon nanoparticles of about 15% wt/vol. to about 60% wt/vol. The paste may then be dispersed in an aqueous-based fluid, for example, with one or more emulsifying surfactants to form an emulsion comprising an internal phase comprising carbon nanoparticles and the oil-based liquid and an external phase comprising the aqueous-based fluid. Examples of suitable emulsifying surfactants may comprise about 0.01% vol/vol to about 5% vol/vol. The aqueous-based fluid may include the aqueous-based fluids previously described herein for mixing with the carbon nanoparticles.

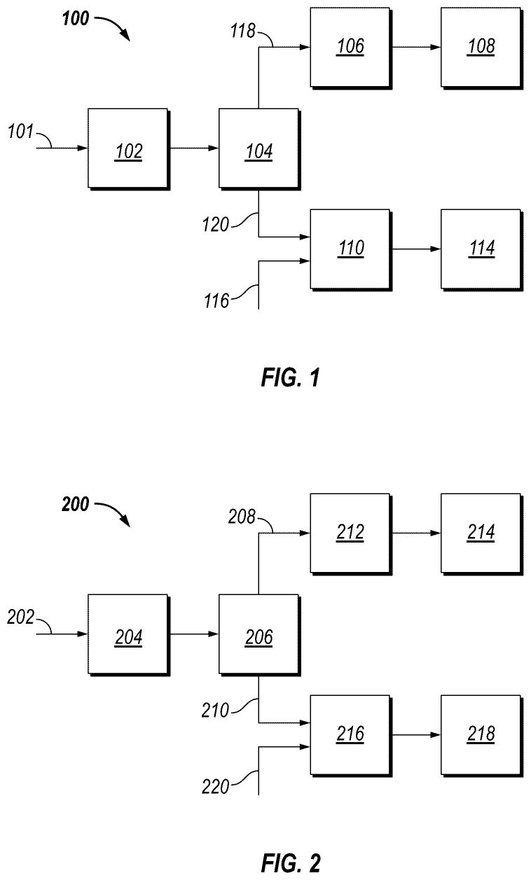

FIG. 1 is a flow chart of a method 100 for powering wellbore equipment using hydrogen. As shown in FIG. 1, methane stream 101 is introduced into microwave pyrolysis unit 102 such as those microwave pyrolysis units previously described. Methane stream 101 may include any suitable source of methane, including methane captured from a wellhead and/or surface production equipment. The microwave pyrolysis unit 102 is configured to pyrolyze at least a portion of the methane from methane stream 101 to form a product stream containing hydrogen and carbon nanoparticles. The product stream from microwave pyrolysis unit 102 is introduced into separation unit 104 where the product stream is separated into solid products 120 containing the carbon nanoparticles and gas stream 118 containing the hydrogen and other gasses present in the product stream of microwave pyrolysis unit 102.

At least a portion of the hydrogen from gas stream 118 is introduced into wellbore equipment 108. In embodiments, hydrogen from gas stream 118 is introduced into a hydrogen fuel cell 106 to generate electricity to power wellbore equipment 108. In other embodiments, hydrogen from gas stream 118 is directly burned in an engine associated with the wellbore equipment to power the wellbore equipment (not shown). While not shown in FIG. 1, additional equipment to capture, purify, store, transport, and compress the hydrogen may be utilized to deliver the hydrogen to wellbore equipment 108 in a state where the hydrogen is useable by wellbore equipment 108. Separation unit 104 can include any of the previously discussed separation units. From separation unit 104, the solid product 120 is introduced into an optional second separation unit (not shown) whereby additional solids are removed. From separation unit 104 or optional second separation unit (not shown), the carbon nanoparticles are introduced into blending unit 110. In blending unit 110, the carbon nanoparticles are mixed with a liquid provided from liquid stream 116. Liquid stream 116 can include aqueous or oil-based liquids as discussed above. The slurry stream from blending unit 110 containing the liquid from liquid stream 116 and carbon nanoparticles from solid product 120 is withdrawn from blending unit 110 and introduced into storage unit 114. From storage unit 114, the slurry containing the carbon nanoparticles and liquid can be utilized for rubber products, composites, plastics, pigments in inks and paints, purification systems, pencils, and energy storage systems, for example.

Carbon black may be used as reinforcing filler in rubber products, such as tires and conveyor belts, to improve their strength and wear resistance. Carbon black may also be added to plastics to act as an extending agent for circuit boards and other electrical components. It may be added to cement to enable the cement to be conductive and to store energy as capacitors or thermal energy. Carbon black may be utilized as a black pigment in inks and paints. Activated carbon may be used for adsorption of gases, purification of liquids, and in air and water purification systems. Activated carbon may be employed in water treatment, air filters, gas masks, and various industrial processes to remove impurities and contaminants. Graphite may be used as a lubricant in various industrial applications, such as in the manufacturing of pencils. Graphite may also be a key component in the production of electrodes for electric arc furnaces, batteries, and in nuclear reactors as a moderator. Carbon composites may be used as a reinforcing material in composite materials. Carbon fibers are combined with resins to create carbon fiber-reinforced composites. These materials are lightweight, strong, and have high stiffness, making them ideal for aerospace, automotive, and sporting goods applications. Carbon steel may be used in the construction industry, manufacturing, and infrastructure for its strength, durability, and versatility. Common applications include structural steel, pipelines, automotive parts, and machinery. Carbon in energy storage may be used in energy storage devices. For example, carbon may be a key component in the anodes of lithium-ion batteries and supercapacitors, contributing to their energy storage capabilities. Carbon may be used as a reducing agent in metallurgical processes, such as the extraction of metals from their ores. For instance, carbon may be utilized in the production of iron from iron ore in the form of coke in a blast furnace.

FIG. 2 is a flow chart of method 200 for powering wellbore equipment using hydrogen. As shown in FIG. 2, methane stream 202 is introduced into microwave pyrolysis unit 204 such as those microwave pyrolysis units previously described. Methane stream 202 may include any suitable source of methane, including methane captured from a wellhead and/or surface production equipment. Microwave pyrolysis unit 204 is configured to pyrolyze at least a portion of the methane from methane stream 202 to form a product stream containing hydrogen and carbon nanoparticles. The product stream from microwave pyrolysis unit 204 is introduced into separation unit 206 where the product stream is separated into solids products 210 containing the carbon nanoparticles and gas stream 208 containing the hydrogen and other gasses present in the product stream of microwave pyrolysis unit 204.

At least a portion of the hydrogen from gas stream 208 is introduced into a generator 212 and combusted to generate electricity to power wellbore equipment 214.

Separation unit 206 may include any of the previously discussed separation units. From separation unit 206, solid products 210 is introduced into an optional second separation unit (not shown) whereby additional solids are removed. From separation unit 206 or optional second separation unit (not shown), the carbon nanoparticles are introduced into blending unit 216. In blending unit 216, the carbon nanoparticles are mixed with a liquid provided from liquid stream 220. Liquid stream 220 can include aqueous or oil-based liquids as discussed above. The slurry stream from blending unit 216 containing the liquid from liquid stream 220 and carbon nanoparticles from solids products 210 is withdrawn from blending unit 216 and introduced into storage unit 218. From storage unit 218, the slurry containing the carbon nanoparticles and liquid can be utilized for rubber products, composites, plastics, pigments in inks and paints, purification systems, pencils, and energy storage systems, for example.

The hydrogen generated from methane decomposition may be supplied to a fuel cell in accordance with one or more embodiments for generation of electricity. The fuel cells may be stationary or mobile. The electricity generated by the fuel cells may be used for any suitable purpose. In some embodiments, the fuel cells may be used to power well equipment, such as fracturing equipment at a well stimulation site. The fuel cells may be coupled to the well equipment via a DC/AC converter and, in some embodiments, via a variable frequency drive (VFD). The fuel cells may be arranged in a fuel cell stack that is used to generate electricity to power various electrical devices (e.g., electric motors) on the well equipment. For example, the fuel cells may be coupled to electric motors on pumping units and used to drive hydraulic pumps on the pumping units, thereby pumping fracturing fluid to a wellhead at a desired pressure. The hydraulic pumping units may include one or more reciprocating pumps, centrifugal pumps, vane pumps, or other types of pumps. Fuel cells may be used to power other equipment on location as well, including a blender unit, a gel/ADP mixer unit, sand handling equipment, liquid handling equipment, a control center (e.g., tech center), and others. The well equipment may be driven partially or entirely by electrical power generated using the fuel cells, as opposed to diesel engines that are conventionally used on location.

While the preceding descriptions describes the use of methane gas released from a wellhead, present embodiments are not limited to the use of methane from a wellhead. Rather, any suitable source of methane may be used for methane decomposition. Examples of suitable methane sources include, but are not limited to, captured methane from the wellhead, captured methane from landfills, captured methane from cattle and dairy farms, or captured methane from steam methane reforming. In some embodiments, methane gas from a wellhead may be supplemented with additional fuel delivered to the location. In some embodiments, the methane gas may include waste gas this is typically flared.

Accordingly, the present disclosure may provide methods and systems of powering wellbore equipment using hydrogen produced from pyrolysis of methane, and, more particularly to methods of methane pyrolysis which include capturing generated carbon nanoparticles in a separator to form a slurry stream or paste which includes the carbon nanoparticles. The methods and systems may include any of the various features disclosed herein, including one or more of the following statements.

Statement 1. A method comprising: pyrolyzing at least a portion of the methane from a methane containing stream to form a product stream comprising at least hydrogen and carbon nanoparticles; and contacting at least a portion of the carbon nanoparticles with a liquid to form a composition comprising the liquid and the carbon nanoparticles.

Statement 2. The method of Statement 1, wherein the pyrolyzing comprises feeding the methane into a microwave pyrolysis unit.

Statement 3. The method of Statement 1 or Statement 2, wherein the pyrolyzing comprises exposing the methane to microwave plasma.

Statement 4. The method of any previous Statements 1-3, further comprising powering wellbore equipment with at least a portion of the hydrogen.

Statement 5. The method of any previous Statements 1-4, further comprising feeding the at least the portion of the hydrogen into a hydrogen fuel cell powering the wellbore equipment.

Statement 6. The method of any previous Statements 1-5, further comprising feeding the at least the portion of the hydrogen into an internal combustion engine powering the wellbore equipment.

Statement 7. The method of any previous Statements 1-6, further comprising separating the product stream into at least a gas stream and a solid product comprising the carbon nanoparticles.

Statement 8. The method of any previous Statements 1-7, further comprising flowing the solid product with an additional gas to a mixing unit for mixing with the liquid, wherein at least a portion of the additional gas is separated from the solid product before the contacting at least the portion of the carbon nanoparticles with the liquid.

Statement 9. The method of any previous Statements 1-8, further comprising separating the product stream into at least a gas stream and a solid stream, wherein the solid stream contains greater than 95 mol. % of carbon nanoparticles.

Statement 10. The method of any previous Statements 1-9, further comprising mixing the liquid and the carbon nanoparticles in a separation unit, wherein the hydrogen is separated from the carbon nanoparticles in the separation unit.

Statement 11. The method of any previous Statements 1-10, wherein the composition is in the form of a slurry, and wherein the liquid is an oil-based liquid.

Statement 12. The method of any previous Statements 1-11, wherein the liquid comprises at least one oil-based liquid selected from the group consisting of a mineral oil, C₆-C₂₀ hydrocarbon, a C₆-C₂₀ alcohol, ethylene glycol monomethyl ether, ethylene glycol monobutyl ether, polypropylene glycol, and any combinations thereof.

Statement 13. The method of any previous Statements 1-12, wherein the composition is in the form of a slurry, and wherein the liquid is an aqueous-based liquid comprising a water-wetting surfactant.

Statement 14. The method of any previous Statement 1-13, wherein the liquid is an aqueous-based liquid comprising a water-wetting surfactant, wherein the water-wetting surfactant comprises at least one surfactant selected from the group of sodium dodecyl sulfate, sodium dodecyl benzene sulfonate, a polyoxyethylene sorbitan based surfactant, ethoxylated nonylphenol surfactant, an ethoxylated alcohol, and any combination thereof.

Statement 15. The method of any previous Statement 1-14, wherein the composition is in the form of a paste, wherein the liquid comprises an oil-based liquid, and wherein the method further comprises emulsifying the paste in an aqueous-based liquid.

Statement 16. A system comprising: a pyrolysis unit fluidly connected to a methane feed; a separation unit fluidly connected to the pyrolysis unit; and a blending unit fluidly connected to the separation unit for blending a liquid with a solid product from the separation unit.

Statement 17. The system of Statement 16, further comprising oilfield equipment configured to be powered by hydrogen from the separation unit.

Statement 18. The system of Statement 16 or Statement 17, further comprising a hydrogen fuel cell configured to receive at least a portion of the hydrogen from the separation unit, wherein the oilfield equipment is configured to receive power from the hydrogen fuel cell.

Statement 19. The system of any previous Statements 16-18, further comprising a generator configured to receive at least a portion of the hydrogen from the separation unit, wherein the oilfield equipment is configured to receive power from the generator.

Statement 20. The system of any previous Statements 16-19, wherein the pyrolysis unit comprises a microwave pyrolysis unit.

To facilitate a better understanding of the present invention, the following examples of certain aspects of some embodiments are given. In no way should the following examples be read to limit, or define, the entire scope of the disclosure.

### EXAMPLES

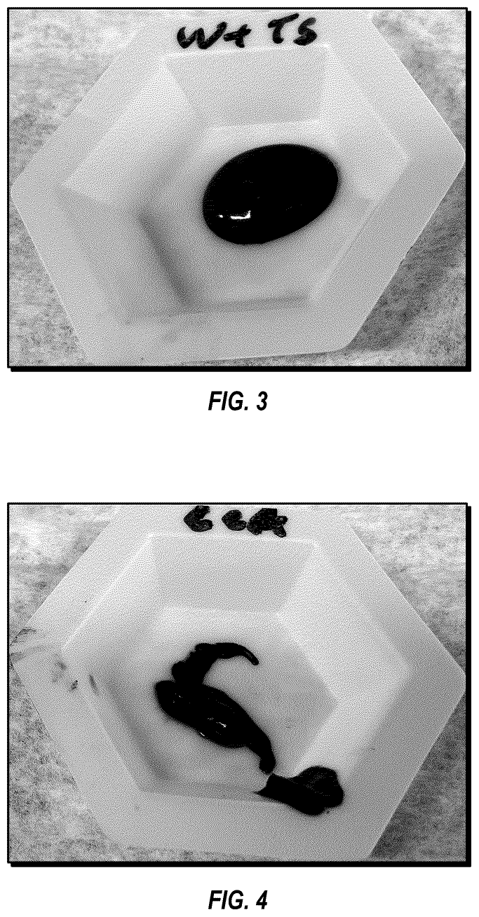

In this Example, carbon nanoparticles were tested for dispersibility in aqueous-based fluids and oil-based fluids. A first aqueous-based fluid was prepared by measuring 0.5 grams of carbon nanoparticles which was added to 4 mL of tap water containing 0.2 v/v of a water-wetting surfactant. The components were mixed for a period of 1 minute with a spatula and it was observed that a pourable, homogenous slurry of solid carbon was formed. FIG. 3 is a photograph showing the liquid.

In another embodiment, an oil-based fluid was prepared by measuring 0.5 grams of carbon nanoparticles which was added to 4 mL of an oil-based fluid containing hydrotreated distillate. The components were mixed for a period of 1 minute with a spatula and it was observed that a pourable, homogenous slurry of solid carbon was formed. FIG. 4 is a photograph showing the liquid.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular examples disclosed above are illustrative only, as the present disclosure may be modified and practiced in different but equivalent manners apparent to those skilled in the art having the benefit of the teachings herein. Although individual examples are discussed, the disclosure covers all combinations of all those examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method comprising:
pyrolyzing at least a portion of a methane from a methane containing stream to form a product stream comprising at least hydrogen and carbon nanoparticles; and
contacting at least a portion of the carbon nanoparticles with a liquid to form a composition comprising the liquid and the carbon nanoparticles.

2. The method of claim 1, wherein the pyrolyzing comprises feeding the methane into a microwave pyrolysis unit.

3. The method of claim 1, wherein the pyrolyzing comprises exposing the methane to microwave plasma.

4. The method of claim 1, further comprising powering wellbore equipment with at least a portion of the hydrogen.

5. The method of claim 4, further comprising feeding the at least the portion of the hydrogen into a hydrogen fuel cell powering the wellbore equipment.

6. The method of claim 4, further comprising feeding the at least the portion of the hydrogen into an internal combustion engine powering the wellbore equipment.

7. The method of claim 1, further comprising separating the product stream into at least a gas stream and a solid product comprising the carbon nanoparticles.

8. The method of claim 1, further comprising flowing the carbon nanoparticles with an additional gas to a mixing unit for mixing with the liquid, wherein at least a portion of the additional gas is separated from the carbon nanoparticles before the contacting at least the portion of the carbon nanoparticles with the liquid.

9. The method of claim 1, further comprising separating the product stream into at least a gas stream and a solid stream, wherein the solid stream contains greater than 95 mol. % of carbon nanoparticles.

10. The method of claim 1, further comprising mixing the liquid and the carbon nanoparticles in a separation unit, wherein the hydrogen is separated from the carbon nanoparticles in the separation unit.

11. The method of claim 1, wherein the composition is in the form of a slurry, and wherein the liquid is an oil-based liquid.

12. The method of claim 1, wherein the liquid comprises at least one oil-based liquid selected from the group of oil-based liquid consisting of a mineral oil, C₆-C₂₀ hydrocarbon, a C₆-C₂₀ alcohol, ethylene glycol monomethyl ether, ethylene glycol monobutylether, polypropylene glycol, and any combinations thereof.

13. The method of claim 1, wherein the composition is in the form of a slurry, and wherein the liquid is an aqueous-based liquid comprising a water-wetting surfactant.

14. The method of claim 1, wherein the liquid is an aqueous-based liquid comprising a water-wetting surfactant, wherein the water-wetting surfactant comprises at least one water-wetting surfactant selected from the group of water-wetting surfactant consisting of sodium dodecyl sulfate, sodium dodecyl benzene sulfonate, a polyoxyethylene sorbitan based surfactant, ethoxylated nonylphenol surfactant, an ethoxylated alcohol, and any combination thereof.

15. The method of claim 1, wherein the composition is in the form of a paste, wherein the liquid comprises an oil-based liquid, and wherein the method further comprises emulsifying the paste in an aqueous-based liquid.

16. A system comprising:
a pyrolysis unit fluidly connected to a methane feed;
a separation unit fluidly connected to the pyrolysis unit; and
a blending unit fluidly connected to the separation unit for blending a liquid with a solid product from the separation unit.

17. The system of claim 16, further comprising oilfield equipment configured to be powered by hydrogen from the separation unit.

18. The system of claim 17, further comprising a hydrogen fuel cell configured to receive at least a portion of the hydrogen from the separation unit, wherein the oilfield equipment is configured to receive power from the hydrogen fuel cell.

19. The system of claim 17, further comprising a generator configured to receive at least a portion of the hydrogen from the separation unit, wherein the oilfield equipment is configured to receive power from the generator.

20. The system of claim 16, wherein the pyrolysis unit comprises a microwave pyrolysis unit.
